(19) United States
(12) Patent Application Publication
(10) Pub. No.: US 2026/0322084 A1
(43) Pub. Date: Oct. 15, 2026

(54) Support Device of a Cable Carrying System

(71) Applicant: OBO Bettermann Hungary KFT, Bugyi (HU)

(72) Inventors: Kevin KUTSCHELIS, Hemer (DE); Robin Hinz, Fröndenberg (DE); Wolfang GUTT, Menden (DE)

(21) Appl. No.: 19/109,308

(22) PCT Filed: Sep. 27, 2023
(86) PCT No.: PCT/EP2023/076750

§ 371 Date: Mar. 6, 2025

(30) Foreign Application Priority Data
Sep. 28, 2022 (DE) 20 2022 105 479.7

(51) Int. Cl. H02G 3/04; H02G 3/38

(52) U.S. Cl. CPC H02G 3/0456; H02G 3/385

(57) ABSTRACT

A multi-part support device of a cable carrying system with a bottom part to be mounted on the floor and providing a support shaft, and with a top part to be mounted on an end of the support shaft with fastening means, as an assembly base for one or more further parts of the cable carrying system, for example a cover piece, in particular of a cable carrier. The bottom part is substantially U-shaped comprising a base plate to be mounted on the floor, and two opposite side walls molded onto the base plate and forming the support shaft.

### BACKGROUND

The disclosure relates to a support device of a cable carrying system.

Cable carrying systems are used to carry cables and/or lines, typically in a building, such as a factory hall. To carry cables and lines, the cable carrying system has fixed points to which cables and/or lines can be connected or on which they can be held. Cable carriers, such as cable ducts, can also be provided.

In some cases, cable carrying systems are floor-mounted, for example on the factory hall floor, part of a suspended ceiling or a carrier. If the cable carrying system is installed on a factory hall floor, such a cable carrying system is usually configured to be walkable and is therefore configured to be stable enough that a person can easily stand and walk on it without damaging the cable carrying system or the lines or cables carried on it.

A floor-mounted cable carrying system is for instance disclosed in US 2009/0090549 A1.

Support devices are part of a floor-mounted cable carrying system. These support a top-side cover piece at recurring intervals by means of a shaft supported on the floor. An installation space for laying cables and/or lines, including supply lines, is limited at the top by the cover piece and at the bottom by the floor; the cover piece is spaced or raised from the floor by the support devices. Such a support device has a shaft to be mounted on the floor and a bearing for the cover piece on the top side. A crossbeam cantilevered over the shaft is usually used as a bearing. Lateral locking plates connected to the support device can also be provided to form a closed cable duct formed by the floor, the locking length and the side plates.

The cover piece can be a lid, which can also be U-shaped with legs pointing downwards forming the side plates. Alternatively, a cable carrier can be provided on the crossbeam as a cover piece, on or in which cables and lines can be laid, so that two spatially separated, storied-like cable routes are created, i.e. between the floor and the cable carrier on the one hand and within the cable carrier on the other. On the top side, such a cable carrier is usually closed again with a cover piece, such as a lid.

A support device for such a cable carrying system has been brought onto the market by the applicant under the type designation BSS 190 xxx FT. Such a support device has a base plate to be mounted on the floor. Two C-profiles are welded to the base plate, protruding from the base plate and facing each other on the back, which together represent the shaft of the floor support. A C-shaped crossbeam with its back facing upwards is welded onto the upper end of the two C-profiles forming the shaft.

To mount the support device, the base plate is screwed to the floor, such as the factory hall floor. Then, sliding nuts are inserted into the C-profiles providing the shaft in order to attach installation material such as pipe clamps to hold the lines. In addition or as an alternative, cables and/or lines can be laid on the ground adjacent to the shaft. Finally, a cover piece is mounted, which is supported by the crossbeam.

With these support devices, both the manufacture and assembly of the support device or the cable carrying system needs improvement:

In the manufacturing process, the entire support device must be hot-dip galvanized to provide the necessary corrosion protection due to the welding of the individual profiles together. This is energy-intensive and requires reworking at openings and drainage edges.

During the assembly, it is particularly important to secure the support device to the floor along the entire length of the crossbeam to avoid the cable carrying system tipping over, especially if it is to be walked on and force is acting on the end of the cover piece. However, this sometimes proves difficult due to the crossbeam that protrudes beyond the base plate, which makes it difficult or even impossible to easily insert a drill and a screwdriver into the mounting holes made exactly below the crossbeam.

Furthermore, sliding nuts, which are relatively expensive, are used to hold installation material as a means of fastening additional fasteners for lines, for example pipe clamps, which must also be inserted into the profiles forming the shaft or must already have been inserted into them before the front-side closure of the profile channel openings.

To attach the cover piece to the crossbeam, it is usually necessary to drill holes in the crossbeam on site. Since the chips that arise during this process pose a safety risk for the cables and lines laid in the cable carrying system, these have to be removed in a laborious and expensive process using suction. The same applies when using self-drilling screws.

For different cable tray cross-sections (height and width), different sizes of support devices must be provided, which must also be configured according to different weight classes. This results in a wide variety of derivatives.

### SUMMARY

One aspect of the disclosure is to provide a support device and an arrangement of a support device with a cover piece that overcomes the aforementioned disadvantages.

In contrast to the prior art, a core principle of the disclosure is to design the support device in multiple parts: the support device comprises a bottom part and a top part. The top part is mounted on the bottom part, which is mounted on the floor and provides the supporting shaft. The top part can be designed like a crossbeam. The top and bottom parts are not welded together to form the support device (in which case they would be one-piece), but are connected to each other by means of fasteners. Energy is saved by not welding the two parts together. The bottom part and/or the top part can each be in one piece (in which case the support device as a whole is to be regarded as two parts) or designed as multiple parts.

The connection between the top and bottom parts can be made either at the factory or on site. In the latter case, the bottom part, which has outwardly projecting mounting tabs or a base plate accessible from above, can be mounted on the floor without the top part, which usually projects beyond the shaft, being an obstacle, so that it is possible to attach the bottom part to the ground even at points where the top part, when mounted, extends over the shaft.

Furthermore, any installation material to be mounted can be more easily mounted on the shaft of the bottom part before mounting the top part. In contrast to the prior art, the top part, which has not yet been mounted, does not make such installation more difficult.

While the bottom part comprising the shaft significantly influences the height of the cable route or tray provided by the support device, the top part influences the width of the cable route or tray. By providing a separation between the top and bottom parts, an interface is provided between the top and bottom parts with regard to the connection of the two parts. This can be kept the same with regard to certain dimensions (such as the distance between various fasteners, the width of a receptacle, etc.). This means that a bottom part for a first height can easily be combined with top parts designed for different widths, and vice versa. Usually, a standardized interface is provided for within a load class, and typically different interfaces are provided for different load classes. Such an interface is usually designed by means of matching fasteners. In this way, significantly fewer different support devices need to be kept in stock to simultaneously provide the necessary variety. The fasteners on the bottom and top parts are designed the same within different parts of a load class, so that any combination of bottom and top parts can be used.

When using galvanized parts (top and bottom part), subsequent hot-dip galvanizing during the production process is not necessary if the top part is attached to the bottom part by means of additional fasteners, unlike a welded connection between these two parts. In particular, the bottom part and/or the top part can be designed as a bent part, in particular as a stamped and bent part. The bottom part can be designed essentially in the shape of a U by using a base plate and two opposing side walls connected to the base plate to form the supporting shaft. The top part is then mounted on the upper ends of the side walls. The top part can also be folded as a U or C profile or provided by means of a corresponding profile. To protect against corrosion, the folded components can be made of corrosion-resistant material or pre-coated material, such as galvanized material, which is considerably less expensive than hot-dip galvanizing. Pre-coated material is already coated with an anti-corrosion layer before processing, so that subsequent coating is not necessary. Even corrosion-resistant materials would have to be reworked after welding, for example by pickling and subsequent passivation in the area of the weld seam.

The side walls are preferably molded onto opposite sides of the base plate, typically by bending them accordingly. The base plate has recesses so that the bottom part can be attached to the floor, preferably with slots aligned transversely to each other for precise alignment. The longitudinal extension of the base plate follows the longitudinal direction of the top part to ensure transverse support of the cable carrying system.

The base plate can have two support areas with which it contacts the floor and on which it is mounted to the floor. The recesses mentioned above are then arranged in the support areas. The base plate may have recesses between these support areas or the support device is in any case spaced from the floor in between. The support areas in between are not too large. The purpose of this is to ensure that the support device makes local contact with the floor, in order to project over any unevenness in the floor between the mounting areas. This means that the support device can be mounted, for example, at slab transitions in factory hall floors, which are naturally uneven, without the entire downward-facing part of the support device having to rest on the floor. This also bridges impure edges at plate boundaries, without the support device being unstable on these uneven areas.

For mounting the top part to the bottom part, a receptacle is preferably formed on the support shaft into which the top part can be inserted. This receptacle can be provided by the side walls of the shaft. A receiving space is then located between the end sections of the side walls, into which the top part is to be inserted. The top part is then laterally enclosed, at least in sections, by the side wall sections. Preferably, the bottom-part-side fasteners for making a connection with the top part are located in the side wall sections of the bottom part that provide the enclosure for the receiving space.

Various fasteners, including combinations thereof, can be provided for the force-fitting connection of the top part to the bottom part, for instance at least one screw connection and/or snap-in connections. For example, corresponding or complementary snap-in structures can be provided on the top and bottom parts, which engage with each other in a form-fitting manner when the top part is mounted. Snap-in structures can be produced in a punching process without much effort and offer high holding forces with minimal assembly effort. For example, the top part can have a positive snap-in structure, such as a snap-in projection, while the bottom part has a negative snap-in structure, such as a recess, into which the positive snap-in structure engages when the top part is mounted. For a form-fitting connection, the positive snap-in structure is usually made of the material surrounding the snap-in structure, and the front side of the sheet metal providing the snap-in structure, which is separated from the surrounding material, preferably points in the direction of loading. A high section modulus is provided by the material pointing in the direction of the load.

It is preferable for the front sides of the snap-in structures to rest against each other in the direction of the force of gravity when mounted. This ensures that the main load direction—the direction of the force of gravity or weight—is supported particularly securely, which is an advantage when it comes to a walkable cable carrying system.

In many cases, several snap-in structures will be provided, which can also be arranged opposite each other, preferably in alignment.

The at least one positive snap-in structure usually extends into the receiving space. If the receptacle is provided by the side walls of the bottom part and the top part is received between the side walls, the side walls can be elastically spread during assembly to create space for the positive snap-in structures during insertion of the top part. The material elasticity of the bottom part causes the side walls to return as soon as the positive snap-in structures engage in the negative snap-in structures. The bottom part is thus secured to the top part.

To secure such a snap-in connection or as also as an alternative thereto, at least one securing element can be provided, such as a sheet metal securing element, a riveted or split pin connection, or guide elements that prevent unintentional bending. Against this background, the direction of action of the securing element, if used, is usually in the direction of the side wall expansion. However, a screw connection between the top and bottom parts is preferred, also in the aforementioned side wall expansion direction. Their longitudinal extension is usually transverse to the direction of gravity. Preferably, both side walls are screwed to the top part at least at one point, preferably at several points. This also stabilizes the bottom part against torsional loads. If the bottom part is essentially U-shaped, it is closed in its course by the top part, so that a pushing movement of the side walls is prevented.

It is preferably provided that the shaft has a first width along its course in a section adjacent the base plate and a second, smaller width in an adjoining section. The width direction usually points in the longitudinal direction of the top part. The first width may be at least twice as large as the second width, more preferably about three times as large. The section of this first width preferably transitions essentially continuously into the section of the second, smaller width, for example by forming a slope with an angle of approximately between 7° and 20°. The first section does not have to be particularly high. It is usually sufficient if it extends only over about ⅕ or ⅙ of the height of the section of the second width or less in the longitudinal direction of the shaft. It provides stabilization of the support device and the base plate on the floor.

In addition, or on its own, the end section of the shaft facing the top part can be configured to have a third width that is greater than the second width, so that this section projects beyond the second section. This third section preferably provides the receptacle for the top part. In particular, it is provided that the means for fastening the top part to the bottom part will be arranged in the area of the third section that extends beyond the second section. This ensures a particularly safe application of force due to the large lever arm.

The shaft is usually less thick than wide along its entire length. The thickness of the shaft is perpendicular to the longitudinal direction of the width. For example, the distance between the two side walls is less than their width.

If the shaft is provided by means of side walls of a bottom part that is essentially U-shaped, it may be provided for the stabilization of the side walls that a stabilizing leg, which projects approximately at a right angle from the side wall, is molded onto at least one side of a side wall, and preferably on both sides of the side wall, following the shaft extension of the side wall. The stabilizing leg may be folded from the side wall. It can also only extend over a section along the course of the shaft, preferably in the area of the aforementioned second section. The stabilizing leg prevents the side wall from buckling when weight is applied in the direction of the force of gravity. Preferably, both side walls have at least one, preferably two stabilizing legs.

The stabilizing legs can be configured in such a way that a closed tower is provided in the second section of the side walls by the stabilizing legs extending over to an opposite area of the other side wall. The stabilizing legs can also engage with the opposite side wall or material connected to it, thus also supporting the side walls against each other.

Particularly preferably, both side walls have, on their two sides along the longitudinal extension, opposing stabilizing legs facing each other. These preferably interlock with each other in a comb-like manner. In this way, a particularly torsionally stiff shaft is provided using simple means and without the need for a joint.

Preferably, a comb-like structure of the free stabilizing leg ends is selected, wherein the flanks of the teeth and the corresponding recesses are inclined at an angle relative to the vertical that does not prevent demolding during the bending apart of the two side walls. This angle is at least 45°, preferably at least 55°, in relation to the longitudinal extension of the support shaft. In this way, the side walls are torsionally rigid on the one hand and supported against a pushing movement, while on the other hand it is easily possible to bend open the opposite side walls to insert the top part into a receptacle provided by the side walls, despite this comb-like engagement.

For further stabilization or in areas of the side walls that do not have stabilizing legs across them, one or more stabilizing beads can be incorporated into the side walls at an angle of about 45° relative to the longitudinal extension of the shaft.

Preferably, it is provided that the side walls are stiffened along their substantially entire shaft extension, for example by stabilizing legs and/or by one or more beads. In order to still allow the two side walls to be bent apart for mounting the top part in the receptacle provided by the side walls, the transition from the base plate to the side wall is used as an elastic hinge. Due to the shaft extension, the bending angle in this transition is only very slight for a certain spreading distance in the receptacle for inserting the top part.

To stabilize the base plate, especially against torsion, supporting legs pointing upwards can be arranged at its ends transverse to the side walls. These stabilize the base plate perpendicular to the side walls. These preferably extend between the side walls, so that the side walls are supported in contact with these supporting legs, namely against a movement towards each other that can occur under load during buckling.

For mounting pipe clamps or other installation material on the shaft, at least one, preferably several threaded inserts are preferably inserted into the shaft, on which the installation material can be mounted. Preferably, the thread is configured as a threaded hole. This enables faster and easier assembly; assembly time can be reduced by up to 80% compared to conventional assembly. By preparing threaded holes, no unwanted chips are produced during assembly.

Preferably, the top part has a C-profile in its cross-section. It has a back and two legs that are molded thereon and folded over at their free ends. Compared to the bottom part, the top part can be aligned so that the opening direction of the profile points upwards or downwards. If the C-profile is aligned with its opening facing upwards, a large weight can be transmitted via the top part without the risk of it buckling. If the back of the C-profile points upwards, a continuous mounting surface is provided, for example, for a cable tray. At least one, usually several, openings arranged offset to one another can be provided in these for the passage of connecting elements, such as screw connections. It is preferably provided that at least one, preferably several, threads arranged offset from one another, for example in the form of threaded holes, are introduced into the mounting base in order to be able to mount further elements of the cable carrying system, again without producing any chips. The latter configuration has the advantage that the mounting direction is only possible from above, which considerably simplifies the assembly process.

The top part can also be folded at its distal ends, so that there is also a surface section in the direction of the distal ends of the top part. Consequently, the cavity provided by the C-profile is closed at the ends. Elements such as cover plates can be attached to the side of these surface sections in relation to the top part. It is also possible to attach the downward-pointing leg of a U-shaped cover as a cover piece to these surface sections, for example by means of an essentially horizontal screw connection, so that an upward-pointing screw head of a vertical screw connection in the direction of the weight force, which could be considered a tripping hazard, is avoided.

In a further development, it is provided that a fastening application is connected to the top part as an accessory to the support device. This fastening application is designed in the manner of a sliding nut and forms a mounting base, for example for additional installation material or other elements of the cable carrying system. The fastening application comprises two clamping plates that are spaced apart from each other and face each other with their flat surfaces. These two clamping plates are connected to each other by at least one web, and preferably several spaced-apart webs, which are usually connected to the edge of the two clamping plates, for example molded onto them. Such a fastening application can be configured as a stamped and bent part, for example from a strip-galvanized material; the fastening application can be folded together like a book at the web(s) so that the clamping plates face each other.

The two clamping plates are spaced apart at a distance that allows angled leg extensions of the legs of the C-profiled top to engage between them when the fastening application is pre-assembled on the C-profile. The fastening application is held on the C-profile by friction locking, through the contact between the clamping plates and the leg extensions and the clamping force of the two clamping plates, which is applied to the clamping plates by the web. In order to provide a certain elasticity between the two clamping plates, the web or webs can be designed in a U-shape. The U-shape provides elasticity in the spreading direction between the two clamping plates. Against this background, the web(s) are preferably arranged on only one side of the clamping plates so that the clamping plates can be bent open from the other side. Against this background, it is also understood that the fastening application is a bent part, preferably a stamped and bent part.

In addition, both clamping plates have aligned openings, whereby one clamping plate-the first clamping plate-has a threaded hole in the opening, while the opening in the second clamping plate is larger in diameter than the inner diameter of the threaded hole. The first clamping plate is arranged in the cavity of the C-profile, facing the back of the C-profile. A screw can be passed through the opening, with which installation material or other parts of the cable carrying system can also be attached to the fastening application. By means of the pressure applied by the screw head to the second clamping plate and the tension applied via the thread in the first clamping plate, the two clamping plates are clamped against each other, with the leg extensions of the C-profile sandwiched in between, thus clamping the mounting application to the C-profile.

It is understood that the clamping plates have a length that is greater than the distance between the leg extensions of the C-profile (the clear width of the C-profile in the area of the leg extensions) so that the leg extensions and the clamping plates overlap when mounted. In any case, the length of the first clamping plate is also smaller than the inner width of the legs.

Since the webs bridge the distance between the two clamping plates and are (also) arranged between the leg extensions for this purpose, these are arranged in such a way that they do not prevent the clamping plates from pivoting during assembly.

To mount the fastening application on the C-profile, the fastening application can be pushed onto one end of the C-profile. In a preferred embodiment, however, it is provided that the width of the fastening application in the area of the first clamping plate and the area provided between the leg extensions is smaller in a mounting orientation than the clearance between the leg extensions. In this orientation, the fastening application can be inserted into the C-profile at any point. Then the fastening application is rotated about its vertical axis so that the clamping plates are swung above or below, respectively, the leg extensions and the fastening application reaches its clamping position. Preferably, it is provided that the second clamping plate, in the mounting orientation, protrudes in sections beyond the outer edge of the first clamping plate and contacts the leg extension of the C-profile on the outside. This provides a stop that prevents the fastening application from being inserted further into the space of the C-profile enclosed by the legs. This simplifies the assembly of the fastening application on the C-profile.

Preferably, it is further provided that the fastening application can be inserted into the C-profile with the first clamping plate only in such an orientation in which the second clamping plate provides a stop by the fastening application having a corresponding outer contour.

Preferably, it is further provided that the diagonally opposite corners of the first clamping plate, which are pivoted onto the leg extension to mount the fastening application, are designed as a bevel or radius, so that when the first clamping plate is pushed onto the leg extension, its edges are set at an angle relative to the extension of the edge of the leg extension, approximately an angle of at least 7° to 10°. This makes it easier to slide on. The edge of the clamping plate to be pushed on and/or the edge of the leg extensions can also have a chamfer that acts as a guide ramp.

The above information on the fastening application can, of course, also be used in connection with another C-profile that is not part of a support device.

A support device equipped in this way therefore has a plurality of possible connection points that can be provided at the locations required for further assembly.

Threads, such as threaded holes, can also be incorporated into the top part at appropriate positions for mounting a cover piece. If the top part is designed as a C-profile, these threads are particularly formed in the back of the C-profile.

A cable carrier, such as a cable duct, can be attached, e.g. screwed, to the top of the top part as a cover piece. In this way, the cable carrier is supported by the support devices. Cables and/or lines can be laid on the supporting shaft on the one hand and in the cable carrier on the other, wherein a spatial and thus organizational separation is provided between these two areas.

Preferably, it is provided that the cable carrier has a sequence of elongated holes or slots following its longitudinal extension, preferably on both sides of its longitudinal extension. The top part of the support device has at least one threaded bushing or hole, preferably also on both sides, provided at a corresponding position to the cable carrier. The cable carrier can be attached to the top part using a screw that goes through a (random or arbitrary) slot in the cable carrier.

### BRIEF DESCRIPTION OF THE DRAWINGS

The following description is provided using an example embodiment with reference to the figures, wherein:

FIG. 1 shows an exploded view of a support device,

FIG. 2 shows the support device illustrated in FIG. 1 in an assembled view,

FIG. 3 shows the support device illustrated in FIG. 1, equipped with pipe clamps,

FIG. 4 shows a sectional view of the top part of the support device of FIG. 1,

FIG. 5 shows a three-dimensional view of a fastening application,

FIG. 6 shows a side view of the fastening application illustrated in FIG. 5, and

FIG. 7 shows a bottom view of the fastening application shown in FIG. 5.

In the figures, identical parts are labeled with identical reference numerals.

### DETAILED DESCRIPTION

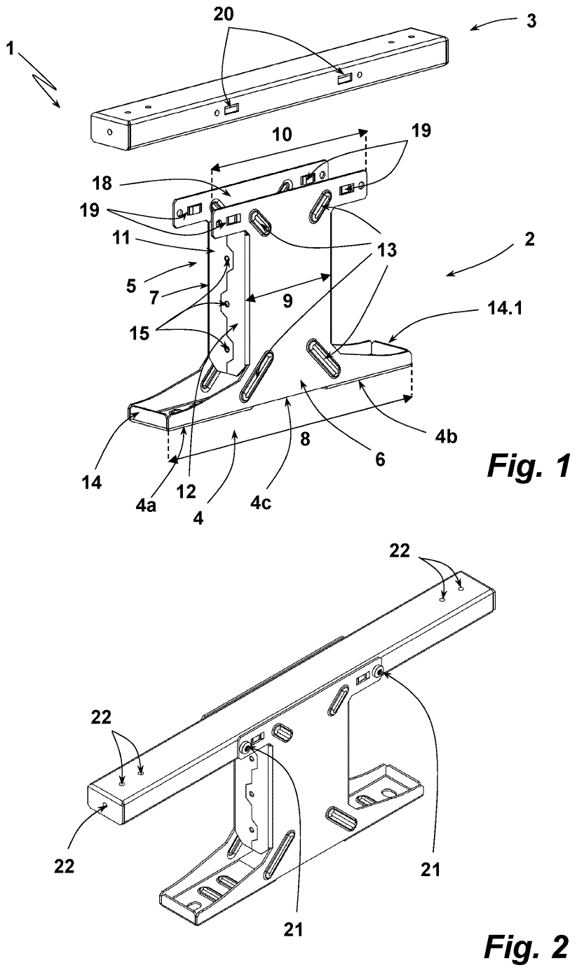

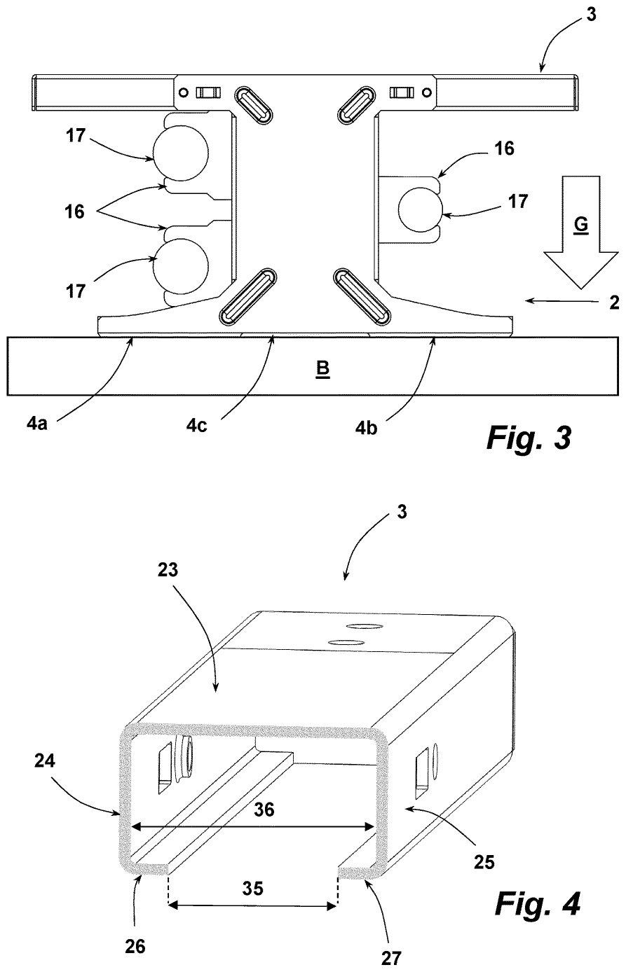

FIGS. 1 to 3 show a support device 1 mounted on a floor B shown only in FIG. 3, such as a factory hall floor, to form a walkable cable carrying system, which is formed in two parts from a bottom part 2 and a top part 3. The bottom part 2 has a base plate 4 for mounting the bottom part 2 on the floor and a support shaft 5.

It can be seen that the base plate 4 is configured to be interrupted (recessed area 4c) and provides two support areas 4a, 4b where the base plate 4 stands on the floor B and is fastened to it.

The bottom part 2 is a stamped and bent part and is made of strip galvanized material. It is essentially U-shaped: the base plate 4 represents the web and the side walls 6, 7 represent the legs of the U. The side panels 6, 7 are not directly connected to each other in a way that would damage the galvanized coating, i.e. they are not welded together.

The side walls 6, 7 are essentially constructed as mirror images of each other, with some complementary elements, as will be explained in more detail below.

Both side walls 6, 7 can be subdivided into three sections of different widths along the shaft length, starting from the base plate 4: a first section of a first width 8, a second section of a smaller width 9 and a third section of a slightly larger third width 10. To stabilize the second section, the walls 6, 7 have a stabilizing leg 11, 12, on both sides of the shaft, projecting perpendicularly from the respective side wall 6, 7 along its entire length.

The free ends of the stabilizing legs 11, 12 engage in each other in a comb-like manner, wherein the respective recesses or prongs have an angle of at least about 55° degrees with respect to the vertical in their non-vertical area. Due to the interlocking of the front sides of the stabilizing legs 11, 12, the side walls 6, 7 are secured against a sliding movement and the supporting shaft 5 is torsion-resistant.

In the sections of greater widths (widths 8 and 10), i.e. those sections in which no stabilizing legs are provided along the sides of the side walls 6, 7, crimps 13 aligned at an angle of 45° are introduced, which stiffen these areas against buckling.

The base plate 4 extends laterally beyond the section of the second width 9 with its support areas 4a, 4b and has at its distal ends folded-over supporting legs 14, 14.1, which extend between the side walls 6, 7. The side walls 6, 7 are supported inwards on these supporting legs 14, 14.1.

Threaded holes 15 running lengthwise in the base plate are inserted in the supporting shaft 5 and in the area of the second width 9. Pipe clamps 16 (shown in FIG. 3) can be mounted on these to hold pipes 17 on the support shaft 5 or the support device 1, respectively.

The top part 3 is also a stamped and bent part, which is made of a strip galvanized material. To complete the support device 1, the top part 3 is inserted between the two side walls 6, 7 into a receptacle 18 pointing upwards through the side walls 6, 7. In order to fix the top part 3 to the bottom part 2 or to the side walls 6, 7, the side walls 6, 7 have opposing, mutually aligned positive snap-in structures 19, here configured as snap-in projections extending from the side walls 6, 7, which engage in complementary negative snap-in structures 20, here configured as recesses, in the top part 3. The positive snap-in structures 19 protrude into the receptacle 18 and thus into the space provided between the side walls 6, 7. The front sides of the positive snap-in structures 19 point in the direction of gravity G, so that a large moment of resistance is provided against the direction of gravity G. In this way, the mounted top part 3 is supported on the bottom part 2 in the direction of the weight G.

To insert the top part 3 into the receptacle 18, the two side walls 6, 7 are spread. Since the two side walls 6, 7 are only connected to one another via the base plate 4, this does not pose a major problem; the length of the support shaft 5 or the side walls 6, 7 means that the transition from the base plate 4 to the side walls 6, 7 only has to be deformed by a small angular amount so that the positive snap-in structures 19 are retracted far enough so that the top part 3 can be inserted into the receptacle 18.

To prevent unintentional bending and to stiffen the entire support device 1, the side walls 6, 7 are to be connected with screws 21. The connection is made in the immediate vicinity of the snap-in connections 19, 20. By means of the snap-in connection 19, 20 and the screw connection 21, the top part 3 and the bottom part 2 are firmly connected to one another, whereby the bottom part 2 is additionally stabilized against torsion by means of the top part 3.

The top part 3 also has threaded holes 22 for mounting cover pieces, such as a cable carrier and/or cover and side protection plates.

FIG. 4 shows a cross-section of the top part 3. The top part 3 is configured as a C-profile in its cross-section. The C-profile is formed by a back 23 and legs 24, 25 molded thereupon, which in turn have angled leg extensions 26, 27 across.

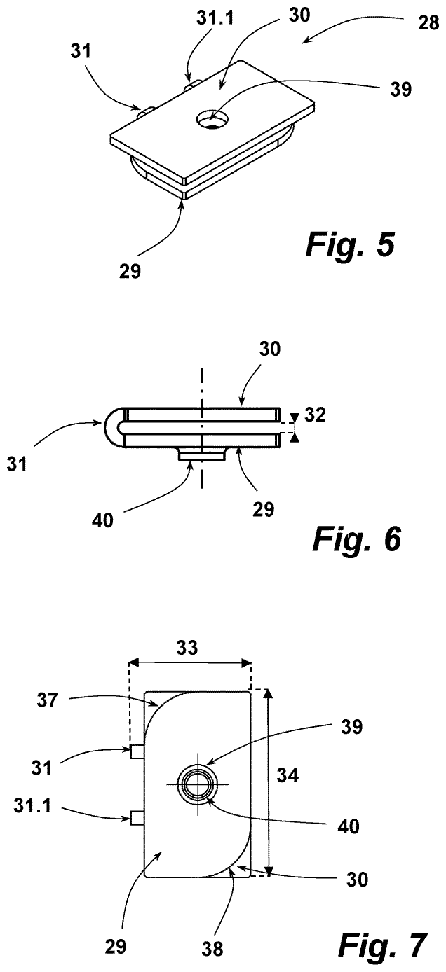

A fastening application 28, as shown in FIGS. 5 to 7, can be attached to this top part 3, which is configured as a C-profile. The fastening application 28 is formed by the two clamping plates 29, 30, which are spaced apart from one another and connected to one another via two U-shaped webs 31, 31.1 molded onto the edges of the clamping plates 29, 30. They are spaced at such a distance 32 from one another that the leg extensions 26, 27 can be arranged between the two clamping plates 29, 30 and at the same time, by means of the webs 31, 31.1 on the clamping plates 29, 30, a clamping force of such a magnitude that the fastening application 28 is held on the top part 3, which is configured as a C-profile, by means of a frictional connection in the course of a pre-assembly.

To mount the fastening application 28 on the top part 3 configured as a C-profile, it is inserted in a first orientation-the mounting orientation-between the leg extensions 26, 27 until the first clamping plate 29 is arranged on one side and the second clamping plate 30 on the other side of the leg extensions 26, 27. Then the fastening application 28 is rotated around its vertical axis so that the first clamping plate 29 is pivoted onto the leg extensions 26, 27. In this way, the leg extensions 26, 27 are clamped between the two clamping plates 29, 30.

In order to insert the fastening application 28 into the space enclosed by the legs 24, 25, the first clamping plate 29, in the mounting orientation, has a width 33 that is smaller than the clear width 35 between the leg extensions 26, 27 (here including the protruding webs 31, 31.1 in this area) and a length 34 that is greater than the clear width 35 between the leg extensions 26, 27 and smaller than the inner width 36 between the two legs 24, 25.

In addition, the diagonally opposite corners 37, 38 of the first clamping plate 29 are provided with a radius, which simplifies pivoting of the first clamping plate 29 onto the leg extensions 26, 27. Providing the rounded edges 37, 38 with a chamfer starting from the side of the first clamping plate 29 facing the second clamping plate 30 further simplifies the assembly process by preventing jamming.

In this rounded area, the second clamping plate 30 extends beyond the first clamping plate 29, so that a stop is provided by the second clamping plate 30, which rests against the outer side of the leg extensions 26, 27 in the assembly orientation.

Both clamping plates 29, 30 each have an opening 39, 40. The opening of the first clamping plate 29 has a threaded hole 40. If the fastening application 28 is pre-assembled in the C-profile, and the leg extensions 26, 27 are arranged between the clamping plates 29, 30, installation material can be fastened to the fastening application 28 by means of a screw, which is not shown in more detail. The pressure force applied by the screw force on the two clamping plates 29, 30 causes them to be pressed together and thus additionally clamped to the leg extensions 26, 27.

The invention was explained using an example embodiment. Without departing the scope of the claims, there are numerous further possibilities for the person skilled in the art to implement the inventive idea, which do not need to be shown or explained in more detail in the context of this disclosure.

List of reference numerals

| | |
|---|---|
| 1 | support device |
| 2 | bottom part |
| 3 | top part |
| 4 | base plate |
| 4a, 4b | support area |
| 4c | recessed area |
| 5 | support shaft |
| 6, 7 | side wall |
| 8 | first width |
| 9 | second width |
| 10 | third width |
| 11, 12 | stabilizing leg |
| 13 | crimp |
| 14, 14.1 | support leg |
| 15, 22 | threaded hole |
| 16 | pipe clamp |
| 17 | pipe |
| 18 | receptacle |
| 19 | positive snap-in structure |
| 20 | negative snap-in structure |
| 21 | screw connection |
| 23 | back |
| 24, 25 | leg |
| 26, 27 | leg extensions |
| 28 | fastening application |
| 29 | first clamping plate |
| 30 | second clamping plate |
| 31, 31.1 | web |
| 32 | distance between clamping plates |
| 33 | width of the first clamping plate |
| 34 | length of first clamping plate |
| 35 | clear width between leg extensions |
| 36 | inner width between legs |
| 37, 38 | opposite corners of the first clamping plate |
| 39 | breakthrough |
| 40 | breakthrough with threaded hole |
| B | floor |
| G | weight force |

1-18. (canceled)

19. A multi-part support device of a cable carrying system, comprising:
a bottom part, which is substantially U-shaped, comprising a base plate mountable to a floor, and two opposite side walls molded onto the base plate and forming a support shaft, and
a top part, which is designed as a crossbeam, mounted on one end of the support shaft with fastening means, as an assembly base for one or more further parts of the cable carrying system,
wherein the fastening means are formed by a screw connection and/or snap-in connection, and
wherein the longitudinal extension of the base plate follows the longitudinal direction of the top part.

20. The support device of claim 19, wherein the support shaft, along an extension thereof directed away from the base plate, has a first width in a first section adjoining the base plate and a second, smaller width in a section adjoining the first section.

21. The support device of claim 19, wherein, along an extension of the support shaft, a stabilizing leg is formed on at least one side of each side wall projecting therefrom.

22. The support device of claim 21, wherein stabilizing legs are formed on both sides of each side wall, and wherein the stabilizing legs of each side wall are aligned opposite the respective stabilizing legs of the other side wall, with end faces thereof interlocking in a comb-like manner.

23. The support device of claim 19, wherein supporting legs pointing upwards and extending between the side walls are formed transversely to the side walls at ends of the base plate, with the side walls supported in contact on the supporting legs.

24. The support device of claim 19, wherein at least one thread is introduced into the support shaft for mounting a pipe clamp or other installation material.

25. The support device of claim 19, wherein for fastening the top part to the bottom part, the support shaft forms a receptacle into which the top part is inserted, and the receptacle has at least one snap-in structure which positively engages in a corresponding snap-in structure in the top part to form a positive locking connection.

26. The support device of claim 25, wherein the positive locking connection formed by the engaged snap-in structures acts in the direction of weight force.

27. The support device of claim 19, wherein the top part is secured to the bottom part via at least one securing element penetrating the side walls as a screw connection.

28. The support device of claim 19, wherein the bottom part and/or the top part is a stamped and bent part made from a sheet metal blank.

29. The support device of claim 19, wherein the bottom part and/or the top part is made of pre-coated or corrosion-resistant material.

30. The support device of claim 19, wherein the top part has a C-shaped cross-sectional profile comprising a back and two legs formed thereon, and the legs have opposing leg extensions.

31. The support device of claim 30, wherein a fastening application is connected to the top part, the fastening application being formed by two clamping plates which are spaced apart from one another, with flat extensions of the clamping plates facing one another and connected to one another by at least one web, wherein a threaded hole is introduced into a first clamping plate of the two clamping plates, and an opening aligned with the threaded hole of the first clamping plate is introduced into a second clamping plate of the two clamping plates, wherein the clamping plates have such a distance from one another that the opposing leg extensions of the legs of the top part are insertable between the clamping plates, and wherein the first clamping plate engages behind at least one leg extension in some areas, and the second clamping plate is arranged on an opposite side of the at least one leg extension, so that the fastening application is clamped to the leg extensions of the top part by a screw engaging the clamping plates.

32. The support device of claim 31, wherein at least two diagonally opposite corners of the first clamping plate are configured as a slope or radius, so that edges of the first clamping plate are set at an angle relative to edges of the leg extensions when the first clamping plate is pushed thereon.

33. The support device of claim 19, wherein at least one thread is introduced in the top part for mounting a cable carrier.

34. A cable carrying system comprising a support device according to claim 33 and a cable carrier, wherein the cable carrier has a succession of elongated holes along a length thereof, and the at least one thread of the top part is arranged correspondingly thereto, and the cable carrier is attached to the top part via a screw that passes through an elongated hole in the cable carrier.
